(19) United States
(12) Patent Application Publication
(10) Pub. No.: US 2026/0015196 A1
(43) Pub. Date: Jan. 15, 2026

(54) WINDER

(71) Applicant: LG ELECTRONICS INC., Seoul (KR)

(72) Inventors: Kipyo PARK, Seoul (KR); Jaesik JUNG, Seoul (KR); Sung-Chul KIM, Seoul (KR); Jae Won LEE, Seoul (KR); Wonje SUNG, Seoul (KR)

(73) Assignee: LG ELECTRONICS INC., Seoul (KR)

(21) Appl. No.: 19/222,654

(22) Filed: May 29, 2025

(30) Foreign Application Priority Data
Jul. 10, 2024 (KR) 10-2024-0091231

(51) Int. Cl. B65H 19/10; B65H 16/02; B65H 19/18; H01M 10/04

(52) U.S. Cl. CPC B65H 19/105; B65H 16/024; B65H 19/1868; H01M 10/0409; B65H 2301/41246; B65H 2301/41354; B65H 2301/46043; B65H 2408/2411; B65H 2408/24153; B65H 2801/72

(57) ABSTRACT

A winder applied can include a turret part configured to hold a running film roll and a standby film roll, and a leading part including a head part configured to sense a finishing tape attached to an end side of a thin film wound on the standby film roll, grip the finishing tape, and remove the finishing tape from the standby film roll. The head part can include a head body part, a sensing unit disposed on the head body part, and a tape adsorption part disposed on the head body part. The tape adsorption part may be configured to move to a position of the finishing tape sensed by the sensing unit, temporarily couple to the finishing tape, and remove the finishing tape from the end side of the thin film wound on the standby film roll. The sensing unit may be configured to sense the finishing tape.

### CROSS-REFERENCE TO RELATED APPLICATION

Pursuant to 35 U.S.C. § 119(a), this application claims the benefit of the earlier filing date and the right of priority to Korean Patent Application No. 10-2024-0091231, filed on Jul. 10, 2024, the contents of which are incorporated by reference herein in their entirety.

### BACKGROUND

### Field

The present disclosure relates to a winder used to manufacture an electrode of a secondary battery.

### Description of the Related Art

A secondary batteries is a rechargeable battery used as a battery for various devices such as cellular phones, laptop computers, camcorders, and vehicles. In addition, the secondary battery has a structure in which pre-manufactured electrodes (positive and negative electrodes) and separation membranes are alternately stacked on each other.

A process of manufacturing electrodes (positive electrodes and negative electrodes) of the secondary battery generally includes a coating process, a roll press process, a slitting process, a notching process, and a drying process.

In the coating process, an active material is coated on one surface or both surfaces of a current collector (mainly a copper foil for a negative electrode, and mainly an aluminum foil for a positive electrode), i.e., a film for coating. In the roll press process, the film coated with the active material on the surface of the current collector, i.e., a film for roll press is compressed while passing between a pair of press rolls.

After the roll press process is performed, a film having a plurality of rows of active material layers arranged in parallel on the surface of the current collector, i.e., a film for slitting is constituted. In the slitting process, a boundary between an uncoated portion of the film for slitting and the active material layer is cut. Here, the uncoated portion is a portion of the current collector exposed to outside between respective rows of the active material layers.

When the slitting process is performed, a plurality of films, each having one row of active material layer and one row of an uncoated portion, i.e., a plurality of films for notching can be obtained. In addition, in the notching process, electrode tabs are disposed at regular intervals on the uncoated portion of each film for notching.

When the notching process is performed, a film having one row of an uncoated portion with a plurality of electrode tabs and one row of an active material layer, i.e., a film for drying is obtained. In the drying process, the film for drying is dried to remove moisture from the active material layer.

As such, when electrodes (positive electrodes and negative electrodes) of a secondary battery is manufactured, several processes are performed, and each process is performed using a roll-to-roll method. Accordingly, in each process, an unwinding device configured to unwind films before the process (a film for coating, a film for roll pressing, a film for slitting, a film for notching, and a film for drying), and a rewinding device configured to wind films after the process are used. In addition, with respect to the unwinding device in each process, work for connecting a running film that has been used first but is about to run out with a standby film to be newly used needs to be performed.

Korean Patent Registration No. 10-2594981 discloses an unwinding device for a process of manufacturing a secondary battery electrode. The unwinding device blows air between cut surfaces of new films during electrode replacement to cause a flap to be lifted, and then, grips the lifted flap. When air is blown to lift the flap, the flap may not be gripped accurately or can become folded. In addition, there is a problem in that the unwinding device can be applied as the upper unwinding type to be used only when an electrode is to be unwound, and cannot be applied when an electrode is unwound as a lower unwinding type.

### SUMMARY

Therefore, the present disclosure describes a winder configured to accurately grip a finishing tape (e.g., adhesive tab or other material part) attached to a standby film roll and/or a thin film (an electrode) wound on the standby film roll and applicable to both an upper unwinding type and a lower unwinding type.

An objective of the present disclosure can be achieved by the detailed description to be provided below.

In order to achieve these and other advantages and in accordance with the purpose of this specification, as embodied and broadly described herein, there is provided a winder applied to an upper unwinding type and a lower unwinding type, and including a turret part and a leading part. A running film roll and a standby film roll are arranged on the turret part. The leading part includes a head part. The head part senses a finishing tape attached to an end side of a thin film wound on the standby film roll, grips the finishing tape, and then, removes the finishing tape

In addition, the head part includes a head body part, a sensing unit, a tape adsorption part, and a head rotation part. The sensing unit is disposed on the head body part and senses the finishing tape. The tape adsorption part is disposed on the head body part and moves to a position of the finishing tape sensed by the sensing unit, adsorb the finishing tape, and then, removes the finishing tape. The head rotation part is connected to the leading part and rotates the head body part when the thin film wound on the standby film roll becomes unwound from the upper unwinding type to the lower unwinding type or from the lower unwinding type to the upper unwinding type.

In detail, the tape adsorption part moves forward to an adsorption region of the finishing tape, sucks air to adsorb the adsorption region of the finishing tape, and then, moves backward.

In detail, the head part further includes a film adsorption part. The film adsorption part is disposed on the head body part, and adsorbs and grips one surface at an end side of the thin film wound on the standby film roll.

In detail, the film adsorption part moves forward to an adsorption region of the standby film roll, and then, sucks air to adsorb the adsorption region of the standby film roll. In addition, the film adsorption part moves backward after the tape adsorption part removes the finishing tape attached to one surface of a thin film neighboring the end side of the thin film wound on the standby film roll.

In detail, the head part further includes a film gripping part. The film gripping part is disposed on the head body part and grips the end side of the thin film wound on the standby film roll, together with the film adsorption part.

In detail, when the film adsorption part adsorbs the one surface at the end side of the thin film wound on the standby film roll, and then, moves backward, an end of the thin film is spaced apart from the standby film roll by a preset distance, and the film gripping part moves to come into contact with another surface at the end side of the thin film. The end side of the thin film is placed between the film adsorption part and the film gripping part, and gripped by the film adsorption part and the film gripping part due to close contact between the film adsorption part and the film gripping part.

In detail, when the film adsorption part adsorbs the one surface at the end side of the thin film wound on the standby film roll, and then, moves backward and descends, an end of the thin film is spaced apart from the standby film roll by a preset distance, and the film gripping part comes into contact with another surface at the end side of the thin film. The end side of the thin film is placed between the film adsorption part and the film gripping part, and gripped by the film adsorption part and the film gripping part due to close contact between the film adsorption part and the film gripping part.

In detail, the winder in the present disclosure further includes a guide roller. When the head part moves in a direction away from the standby film roll by a preset distance after gripping an end side of a thin film unwound from the standby film roll, the guide roller moves and supports one point of the thin film to define a moving path of the thin film.

In detail, the winder in the present disclosure further includes a film connecting part and a suction part. The film connecting part connects the running film roll to the standby film roll. The suction part is disposed below the film connecting part and adsorbs a thin film unwound from the standby film roll to fix the thin film. A thin film unwound from the running film roll and a thin film unwound from the standby film roll are stacked on each other to be placed between the film connecting part and the suction part.

In detail, a connection tape that has become unwound to a preset length from a roll, on which the connection tape had been wound, is placed on the film connecting part. One surface at an end side of the connection tape is adsorbed and gripped by a connection tape adsorption part.

In detail, the connection tape adsorption part adsorbs the one surface at the end side of the connection tape, and then, moves in one direction along a first guide member.

In detail, a connection tape pressing part is disposed below the first guide member. When the connection tape adsorption part moves in one direction along the first guide member, the connection tape adsorption part moves from one end portion to another end portion of the connection tape pressing part, and the connection tape unwound from the roll on which the connection tape has been wound is disposed below the connection tape pressing part.

In detail, the connection tape pressing part adsorbs and grips one surface of the connection tape disposed therebelow. The connection tape adsorption part releases the adsorbed connection tape, and moves in an opposite direction to the one direction along the first guide member to return to an original position.

In detail, a connection tape cutting unit is disposed on the one end portion of the connection tape pressing part. The connection tape cutting part cuts the connection tape at one point, and the connection tape cut to have a preset size is adsorbed onto one surface of the connection tape pressing part.

In detail, when the connection tape is cut, the suction part is raised or the film connecting part is lowered. The thin-film cutting unit disposed on the film connecting part cuts the thin film unwound from the running film roll and the thin film unwound from the standby film roll, the thin films being stacked on each other, while moving in one direction along a second guide member.

In detail, the connection tape pressing part moves toward the suction part, and the connection tape adsorbed by the connection tape pressing part connects a thin film connected to the standby film roll to a thin film separated from the running film roll.

According to an embodiment of the present disclosure, since a winder includes a sensing unit, the winder has an effect of accurately gripping a finishing tape and/or a thin film (an electrode) wound on a standby film roll even when a radius of the standby film roll varies or a position of the finishing tape attached to the standby film roll varies.

In addition, the winder in the present disclosure has an effect of capable of unwinding a thin film using an upper unwinding type or a lower unwinding type by rotating a head part configured to grip a finishing tape or a thin film (an electrode).

In addition, since the winder in the present disclosure includes a guide roller movable upwards or downwards, the winder has an effect of capable of leading a thin film when an upper unwinding type is changed to a lower unwinding type (or vice versa).

In addition, in the winder in the present disclosure, a thin film connected to a standby film roll is connected to a thin film separated from a running film roll in a position in which a thin film unwound from the running film roll and a thin film unwound from the standby film roll are cut. Accordingly, effects of preventing connection portions of the thin films from being misaligned, reducing manufacturing time for the winder, simplifying a manufacturing process, and reducing a manufacture cost can be obtained.

Detailed effects of the winder in the present disclosure will be described in the detailed description for implementing the present disclosure.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a diagram illustrating a winder according to an embodiment of the present disclosure;

FIGS. 2 and 3 are diagrams illustrating that the a turret part in the winder of FIG. 1 rotates by a preset angle;

FIG. 4 is a diagram illustrating that a leading part in the winder of FIG. 1 moves forward;

FIG. 5 is a diagram illustrating that a head part of the leading part in the winder of FIG. 4 grips a thin film wound on a standby film roll, and then, moves backward;

FIG. 6 is a diagram illustrating that a thin film of a running film roll and a thin film of a standby film roll are stacked on each other on a suction part in the winder of FIG. 5;

FIG. 7 is a diagram illustrating that the thin film of the running film roll and the thin film of the standby film roll are cut on the suction part in the winder of FIG. 6;

FIG. 8 is a schematic diagram illustrating a standby film roll and a head part in a case of an upper unwinding type;

FIG. 9 is a schematic diagram illustrating a standby film roll and a head part in a case of a lower unwinding type;

FIG. 10 is a top view of the standby film roll and the head part each shown in FIG. 8;

FIG. 11 is a side view of the standby film roll of FIG. 8 (from right to left);

FIG. 12 is a side view of the head part of FIG. 8 (from left to right);

FIGS. 13A and 13B are schematic diagrams illustrating a process in which a film adsorption part and a film gripping part grip and unwind a thin film of a standby film roll;

FIG. 14 is a schematic diagram illustrating rotation of the head part;

FIG. 15 is a diagram illustrating that, in a case of a lower unwinding type, a head part of a leading part grip a thin film wound on a standby film roll, and then, move backward;

FIG. 16 is a diagram illustrating that a guide roller is raised in a winder of FIG. 15;

FIGS. 17A to 17D are schematic diagrams illustrating a process in which a thin film of a running film roll and a thin film of a standby film roll are cut, and then, connected at a film connecting part;

FIG. 18 is a diagram illustrating that a thin film of a running film roll and a thin film of a standby film roll are cut, and then, connected; and

FIG. 19 is a diagram illustrating that a thin film of a running film roll and a thin film of a standby film roll are connected by a connection tape.

### DETAILED DESCRIPTION OF THE EMBODIMENTS

Hereinafter, examples of an embodiment of the present disclosure will be described in detail with reference to the accompanying drawings. In the description of the present disclosure, certain detailed explanations that can be clearly understood and easily reproduced by a person of ordinary skill in the art in view of the related art are omitted when it is deemed that they can unnecessarily obscure the essence of the present disclosure.

The accompanying drawings are merely used to help easily understand an embodiment described herein, and it should be understood that the technical idea of the present disclosure is not limited by the accompanying drawings.

A singular representation can include a plural representation unless it represents a definitely different meaning from the context.

In addition, it will be understood that although the terms first, second, etc. can be used herein to describe various elements, these elements should not be limited by these terms. These terms are generally only used to distinguish one element from another. For example, a first component can be referred to as a second component, and similarly, a second component can be referred to as a first component without departing from the scope of the present disclosure.

Hereinafter, a winder according to an embodiment of the present disclosure is described.

The winder in the present disclosure is a device generally used to manufacture an electrode of a secondary battery.

The winder in the present disclosure is a device generally used as both an unwinder and a rewinder, and applied to both an unwinder and a rewinder.

An unwinder is a device generally used to unwind a thin film wound in a form of a roll and connect an existing film to a new film in a process of manufacturing an electrode of a secondary battery.

In addition, a rewinder is a device generally used to wind an unwound thin film in a form of a roll.

That is, the winder in the present disclosure can be used as both an unwinder and a rewinder.

Hereinafter, among an unwinder and a rewinder to which the winder in the present disclosure can be applied, the unwinder is be described, and this description can be applied to a case of being used as a rewinder.

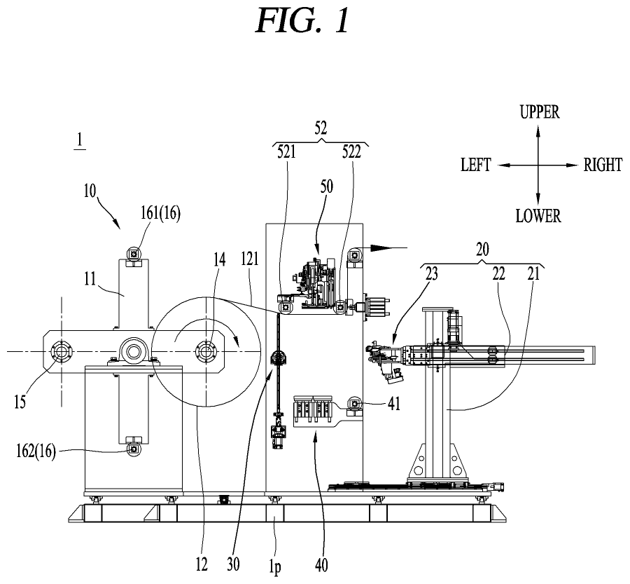

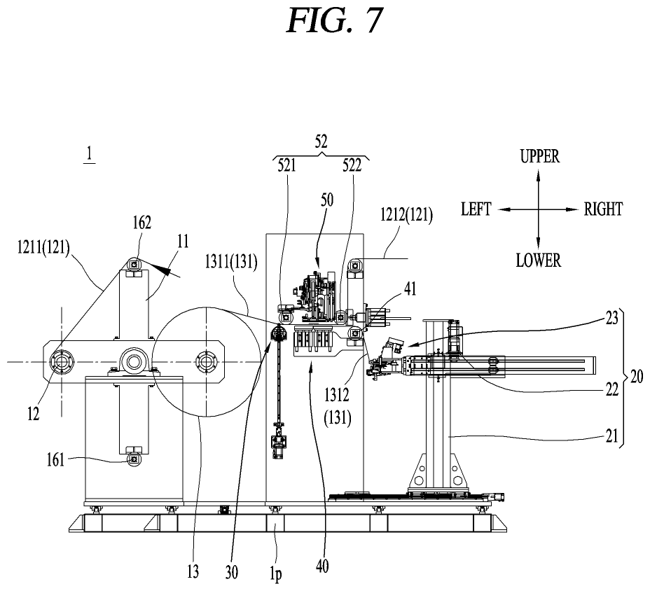

Referring to FIGS. 1 to 7, a winder 1 in the present disclosure includes a turret part 10, a leading part 20, a suction part 40, a film connecting part 50, and a control unit (not shown) each disposed on a frame 1p.

The turret part 10, the leading part 20, the suction part 40 and the film connecting part 50 are disposed on the frame 1p of the winder 1 in the present disclosure, and operations thereof are controlled by the control unit. The operations refer to rotation or movement of the components of the winder 1 in an upward, downward, left, or right direction. In addition, the control refers to adjustment of a rotation angle, a movement distance, etc.

### Turret Part 10

The turret part 10 includes a turret body 11, a running film support part 14, a standby film support part 15, and a plurality of rollers 16.

In FIG. 1, a front side can be defined as a front directed toward a left or right side (or an upper or lower side), and a rear side can be defined as a rear directed backward.

As shown in FIG. 1, the turret body 11 can be configured in a plus (+) shape when the winder 1 in the present disclosure is viewed from the front side, or can be configured to have a circular or oval shape.

A running film roll 12 and a standby film roll 13 are arranged in the turret body 11.

In this specification, a running film roll and a standby film roll refer to not only electrodes but also components having a form of a thin film wound in a roll shape before becoming electrodes.

In this specification, a component having a form of a thin film wound on a running film roll and a standby film roll is referred to as a ‘thin film.’

The running film roll 12 refers to a film currently being unwound on the frame 1p (see FIG. 1).

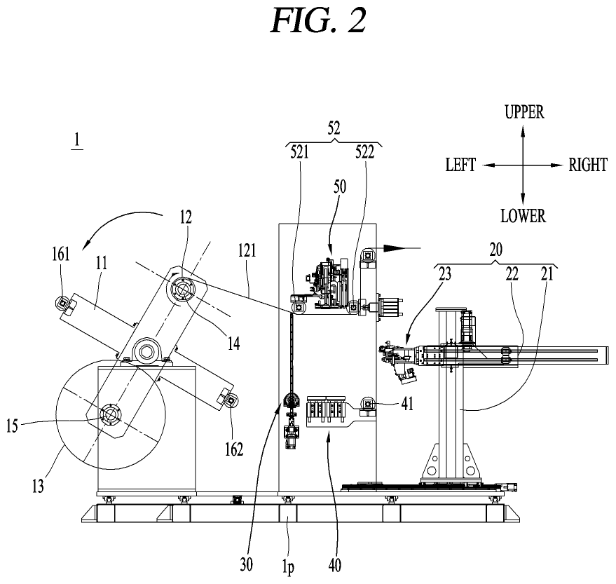

The standby film roll 13 refers to a film unwound following the running film roll 12 when the running film roll 12 is completely unwound (see FIG. 2). After replacement, the standby film roll 13 becomes the running film roll 12.

Types of unwinding a film are classified into an upper unwinding type and a lower unwinding type.

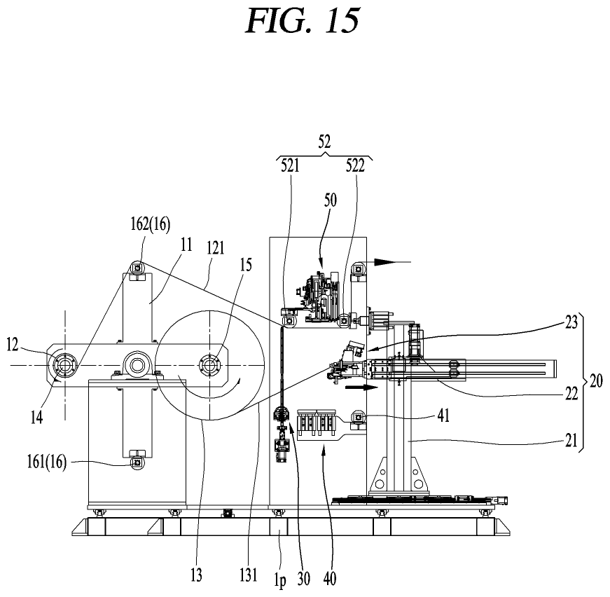

Referring to FIG. 1, the running film roll 12 rotates clockwise and a thin film 121 is unwound from an upper portion. This is referred to an upper unwinding type. Conversely, FIG. 15 illustrates a lower unwinding type such that the running film roll 12 rotates counterclockwise and a thin film is unwound from a lower portion. This identically applies to the standby film roll 13.

The winder 1 in the present disclosure is applied to both upper and lower unwinding types.

The running film roll 12 is placed on the running film support part 14, and the standby film roll 13 is placed on the standby film support part 15.

The running film support part 14 supports the running film roll 12, and the standby film support part 15 supports the standby film roll 13.

The standby film roll 13 is supplied from outside approximately when the running film roll 12 is almost completely unwound (when only a small portion of the thin film 121 remains) to be placed on the standby film support part 15 of the turret body 11 (see FIG. 2).

When the standby film roll 13 is placed on the standby film support part 15, the standby film roll 13 is placed on the standby film support part 15 so that a wound thin film is unwound during clockwise rotation in a case of the upper unwinding type, and the standby film roll 13 is placed on the standby film support part 15 so that a wound thin film is unwound during counterclockwise rotation, in a case of the lower unwinding type (see FIG. 15).

The running film support part 14 and the standby film support part 15 can rotate when placed on the turret body 11.

That is, the running film support part 14 and the standby film support part 15 are rotatably mounted on the turret body 11. The running film support part 14 and the standby film support part 15 can be, for example, rollers.

Accordingly, the running film roll 12 can rotate when placed on the running film support part 14, and the standby film roll 13 can rotate when placed on the standby film support part 15.

The running film roll 12 rotates clockwise in the case of the upper unwinding type, and counterclockwise in the case of the lower unwinding type.

The running film support part 14 and the standby film support part 15 are arranged to be spaced apart from each other by a preset distance. For example, the running film support part 14 and the standby film support part 15 are arranged to be spaced apart from each other by a preset distance in a left-right direction or an upward-downward direction.

For example, as shown in FIG. 1, the running film support part 14 can be placed on a right side, and the standby film support part 15 spaced apart therefrom by a preset distance can be placed on a left side.

Additionally, the turret part 10 includes the plurality of rollers 16.

The plurality of rollers 16 include a first roller 161 and a second roller 162.

The first roller 161 and the second roller 162 support a thin film unwound from the running film roll 12 during replacement between the running film roll 12 and the standby film roll 13.

The first roller 161 and the second roller 162 can rotate when placed on the turret body 11.

The first roller 161 and the second roller 162 are rotatably mounted on the turret body 11. The first roller 161 and the second roller 162 can be well-known rollers.

The first roller 161 and the second roller 162 are arranged to be spaced apart from each other by a preset distance. For example, the first roller 161 and the second roller 162 are arranged to be spaced apart from each other by a preset distance in a left-right direction or an upward-downward direction.

For example, as shown in FIG. 1, when the running film support part 14 is placed on a right side and the standby film support part 15 spaced apart therefrom by a preset distance is placed on a left side, the first roller 161 can be placed on an upper side and the second roller 162 spaced apart therefrom by a preset distance can be placed on a lower side.

Meanwhile, the turret body 11 can rotate. FIGS. 1 to 3 illustrate rotation of the turret part 10 by a preset angle.

The rotation of the turret body 11 is performed by the control unit. The winder 1 in the present disclosure includes a turret support part (no reference numeral) configured to support the turret body 11 on the frame 1p and a turret rotation part (no reference numeral) configured to rotate the turret body 11. The turret rotation part refers to a component configured to rotate the turret body 11, and indicates a motor and other components connected to the motor.

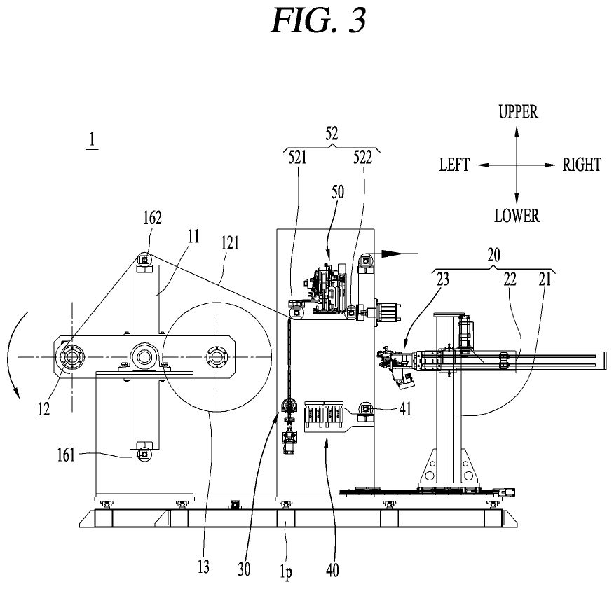

Approximately when the running film roll 12 placed on the running film support part 14 is almost completely unwound (when only a small portion of the thin film 121 remains), the standby film roll 13 is placed on the standby film support part 15. In addition, the turret body 11 rotates by approximately 180° counterclockwise (see FIG. 3).

As the turret body 11 rotates by approximately 180°, the standby film roll 13 having been located on a left side is located on a right side, and the running film roll 12 having been located on a right side is located on a left side.

According to the rotation of the turret body 11, when disposition positions of the running film roll 12 and the standby film roll 13 are changed, the running film roll 12 is positioned at a location far from the guide roller 30 or the leading part 20 each to be described later, and the standby film roll 13 is positioned at a location near the guide roller 30 or the leading part 20 (see FIG. 3).

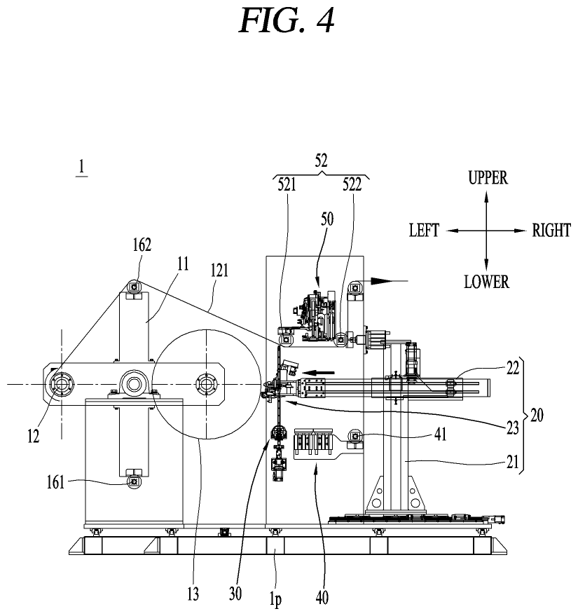

When the rotation of the turret body 11 is completed, the leading part 20 moves toward the standby film roll 13 (see FIG. 4).

### Leading Part 20

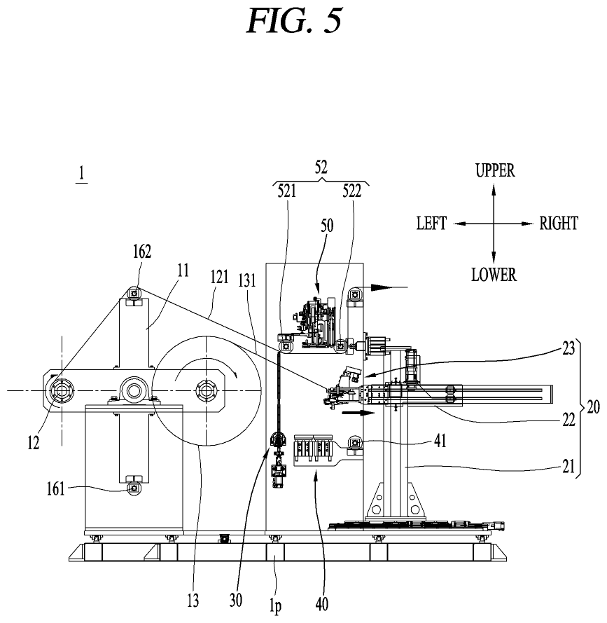

The leading part 20 adsorbs and grips a finishing tape 17 and one surface at an end side of a thin film 131 to which the finishing tape 17 (e.g., adhesive tab or material portion) is not attached to unwind the thin film 131 wound on the standby film roll 13 (see FIG. 5).

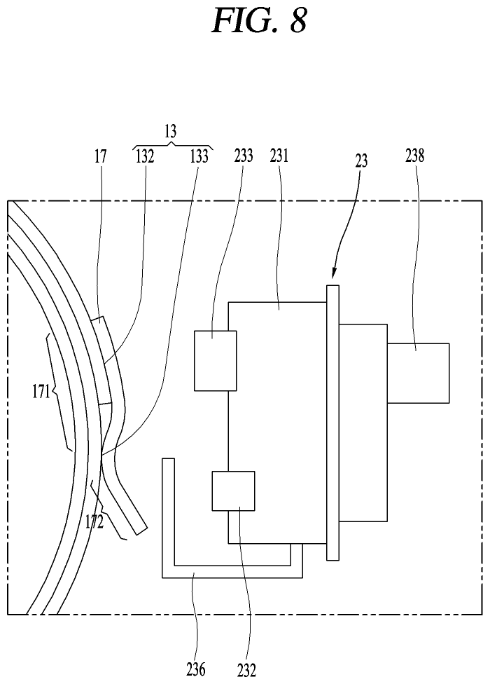

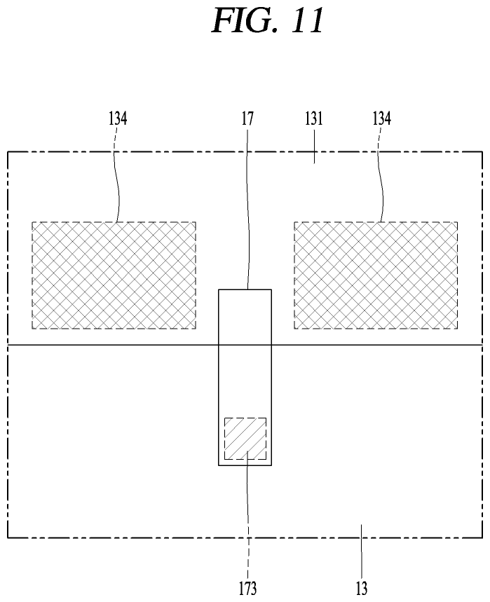

The finishing tape 17 prevents the thin film 131 wound on the standby film roll 13 from being unwound (see FIGS. 8 and 11).

The finishing tape 17 is configured in a tape shape having a preset length in a circumferential direction of the standby film roll 13.

The finishing tape 17 is attached to the one surface at the end side of the thin film 131 wound on the standby film roll 13 to have a longitudinal direction of the finishing tape 17 arranged in a same direction as the circumferential direction of the standby film roll 13.

One surface of the finishing tape 17 is directed toward the standby film roll 13, and another surface (an opposite surface to the one surface) of the finishing tape 17 is directed toward the leading part 20.

The one surface of the finishing tape 17 is divided into an adhesive portion 171 and a non-adhesive portion 172 (see FIG. 8). In addition, a whole of the another surface of the finishing tape 17 has no adhesive strength.

In the finishing tape 17, the adhesive portion 171 is located on one side in the longitudinal direction, and the non-adhesive portion 172 is located on another side in the longitudinal direction.

The adhesive portion 171 of the finishing tape 17 is attached to one surface 132 at an end side of the thin film 131 wound on the standby film roll 13, and one surface 133 of the thin film 131 neighboring the end side of the thin film 131. The one surface 133 of the thin film 131 neighboring the end side of the thin film 131 refers to a surface that is not covered by the one surface 132 at the end side of the thin film 131.

The leading part 20 can move on the frame 1p.

The leading part 20 includes a first leading support part 21 and a second leading support part 22 (see FIG. 1).

The first leading support part 21 can be movably connected to the frame 1p and move in one direction (e.g., a horizontal direction) on the frame 1p.

The second leading support part 22 is movably connected to the first leading support part 21.

The second leading support part 22 can move in a same direction as a movement direction (e.g., a horizontal direction) of the first leading support part 21 when coupled to the first leading support part 21, and can also move in one different direction (e.g., a vertical direction) on the first leading support part 21.

The movement of the leading part 20 (in detail, the first leading support part 21 and the second leading support part 22) is performed by the control unit.

The winder 1 in the present disclosure includes components configured to enable the first leading support part 21 to move on the frame 1p and components configured to enable the second leading support part 21 to move on the first leading support part 21.

The leading part 20 includes a head part 23.

The head part 23 is placed at one side of the second leading support part 22.

According to movement of the first leading support part 21 and/or the second leading support part 22 in one direction (e.g., a horizontal direction), the head part 23 can be moved in the one direction. In addition, according to movement of the second leading support part 22 in another direction (for example, a vertical direction), the head part 23 can move in the another direction.

The head part 23 can move to come into contact with the standby film roll 13.

In detail, the head part 23 can come into contact with the finishing tape 17 attached to the standby film roll 13 and one surface at an end side of the thin film 131 wound on the standby film roll 13.

In detail, the head part 23 comes into contact with an opposite surface (another surface of the finishing tape 17) to the non-adhesive portion 172 among one surface of the finishing tape 17.

In this specification, a region of the finishing tape 17 having the head part 23 (in detail, a tape adsorption part 232) in contact therewith is referred to as an ‘adsorption region 173 of the finishing tape 17,’ and a region of one surface at an end side of the thin film 131 wound on the standby film roll 13, the region having the head part 23 (in detail, a film adsorption part 233) in contact therewith, is referred to as an ‘adsorption region 134 of the standby film roll 13’ (see FIG. 11).

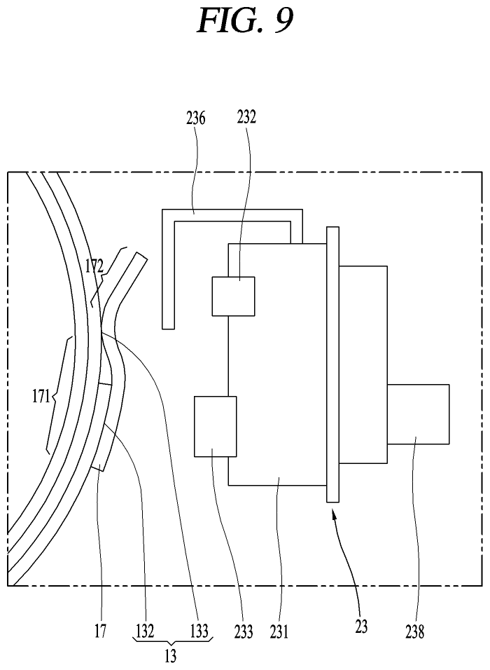

Referring to FIGS. 8 to 12, the head part 23 includes a head body part 231, a sensing unit 234, the tape adsorption part 232, and a head rotation part 238.

### Head Body Part 231

The head body part 231 constitutes a body of the head part 23.

The head body part 231 is placed at one side of the second leading support part 22.

A front surface of the head body part 231 is disposed to face the standby film roll 13, and a rear surface of the head body part 231 is connected to one side of the second leading support part 22.

The sensing unit 234 and the tape adsorption part 232 are placed on the head body part 231.

The winder 1 in the present disclosure includes components configured to connect the head body part 231 to the second leading support part 22.

### Sensing Unit 234

Since the winder 1 in the present disclosure includes the sensing unit 234, even when a radius of the standby film roll 13 varies or a position of the finishing tape 17 attached to the standby film roll 13 varies, the finishing tape 17 and/or a thin film wound on the standby film roll 13 is accurately gripped.

The sensing unit 234 senses the finishing tape 17 and/or the adsorption region 173 of the finishing tape 17.

The sensing unit 234 is placed on the head body part 231 in a position in which the finishing tape 17 can be sensed.

When the head part 23 moves and approaches the standby film roll 13, the standby film roll 13 rotates and the finishing tape 17 passes over a front surface of the head part 23. At this time, the sensing unit 234 senses the finishing tape 17 and/or the adsorption region 173 of the finishing tape 17 and determines a position of the finishing tape 17 and/or the adsorption region 173 of the finishing tape 17.

When the finishing tape 17 is sensed by the sensing unit 234, the rotation of the standby film roll 13 stops.

Then, when the position of the finishing tape 17 is determined by the sensing unit 234, the tape adsorption part 232 of the head part 23 moves to the position of the finishing tape 17 and/or the adsorption region 173 of the finishing tape 17.

The sensing unit 234 can be, for example, a color sensing sensor or a vision sensor.

When the adsorption region 173 of the finishing tape 17 is marked with a particular color (e.g., red), the color sensing sensor senses the particular color and transmits positional data of the adsorption region 173 to the control unit.

The vision sensor recognizes (or photographs) the finishing tape 17 and/or the adsorption region 173 of the finishing tape 17 and transmits positional data of the finishing tape 17 and/or the adsorption region 173 to the control unit.

Movement of the head part 23, rotation and stopping of the standby film roll 13, and operation of the sensing unit 234 are performed by the control unit.

The sensing unit 234 is electrically connected to the control unit, data acquired by the sensing unit 234 is transmitted to the control unit, and the control unit controls movement of the head part 23 and rotation and stopping of the standby film roll 13, etc. based on the data.

### Tape Adsorption Part 232

The tape adsorption part 232 removes the finishing tape 17 attached to the standby film roll 13.

The tape adsorption part 232 includes an air inlet hole.

The tape adsorption part 232 moves forward to the adsorption region 173 of the finishing tape 17, sucks air to adsorb the adsorption region 173 of the finishing tape 17, and then, moves backward.

In other words, the tape adsorption part 232 adsorbs and removes the finishing tape 17 attached to one surface of the thin film 131 neighboring an end of the thin film 131. Accordingly, the end of the thin film 131 wound on the standby film roll 13 is brought into a state capable of being unwound.

The tape adsorption part 232 is disposed on the head body part 231 to be apart from the sensing unit 234, and placed in a position in which the finishing tape 17 can be adsorbed.

The winder 1 in the present disclosure includes components that enable the tape adsorption part 232 to move forward or backward, and components needed for the tape adsorption part 232 to suck air.

According to an embodiment of the present disclosure, the head part 23 in the present disclosure can further include a thin-film fixing part 235.

### Thin-Film Fixing Part 235

The thin-film fixing part 235 is placed on the head body part 231.

When the tape adsorption part 232 removes the finishing tape 17, the thin-film fixing part 235 comes into contact with the thin film 131 of the standby film roll 13 adjacent to the finishing tape 17 to grab the thin film 131. Since the thin-film fixing part 235 is disposed, when the finishing tape 17 is removed from the thin film 131, a portion of the thin film 131 to which the finishing tape 17 is attached and another portion of the thin film 131 adjacent to the portion of the thin film 131 do not move. Thus, the finishing tape 17 can be easily removed from the thin film 131 without damaging the thin film 131.

The thin-film fixing part 235 can be, for example, a roller. Accordingly, when the thin-film fixing part 235 moves upward or downward while in contact with the thin film 131, the thin-film fixing part 235 can move freely without damaging the thin film 131.

The thin-film fixing part 235 is positioned on the head body part 231 to be apart from the tape adsorption part 232 and the film adsorption part 233.

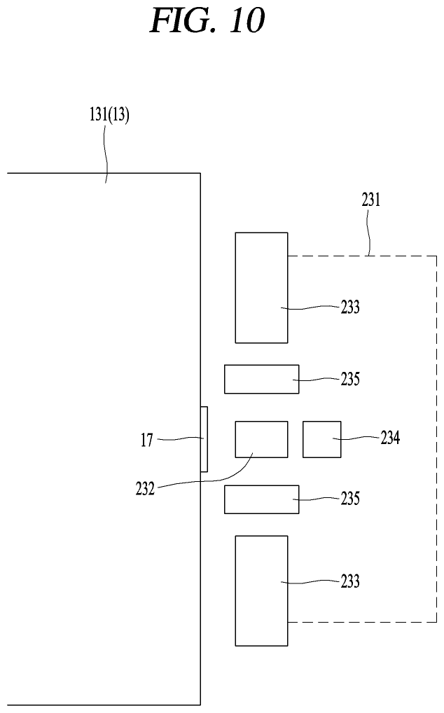

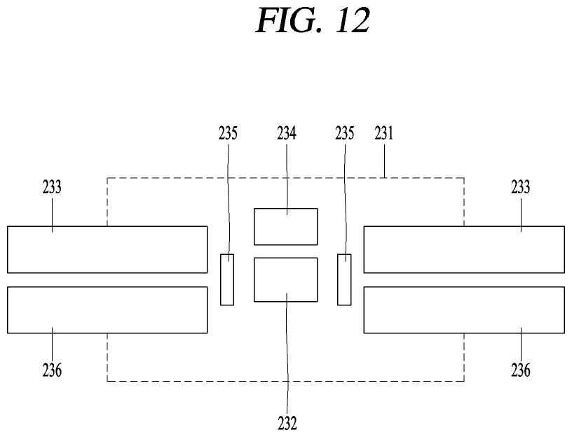

The thin-film fixing part 235 can be provided in plurality. For example, as shown in FIGS. 10 and 12, two thin-film fixing parts 235 can be placed at both sides to have the tape adsorption part 232 in a middle in a width direction of the standby film roll 13.

According to an embodiment of the present disclosure, the thin-film fixing part 235 can be placed between a plurality of (e.g., two) film adsorption parts 233.

The winder 1 in the present disclosure includes components configured to connect between the thin-film fixing part 235 and the head body part 231.

According to an embodiment of the present disclosure, the head part 23 in the present disclosure can further include the film adsorption part 233.

In other words, the winder 1 in the present disclosure can include only the tape adsorption part 232, or can further include the film adsorption part 233 in addition to the tape adsorption part 232.

### Film Adsorption Part 233

The film adsorption part 233 is placed on the head body part 231.

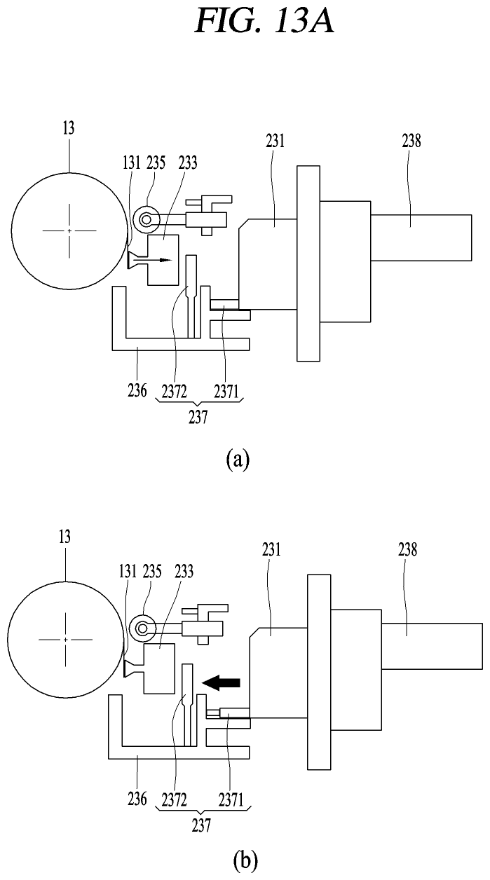

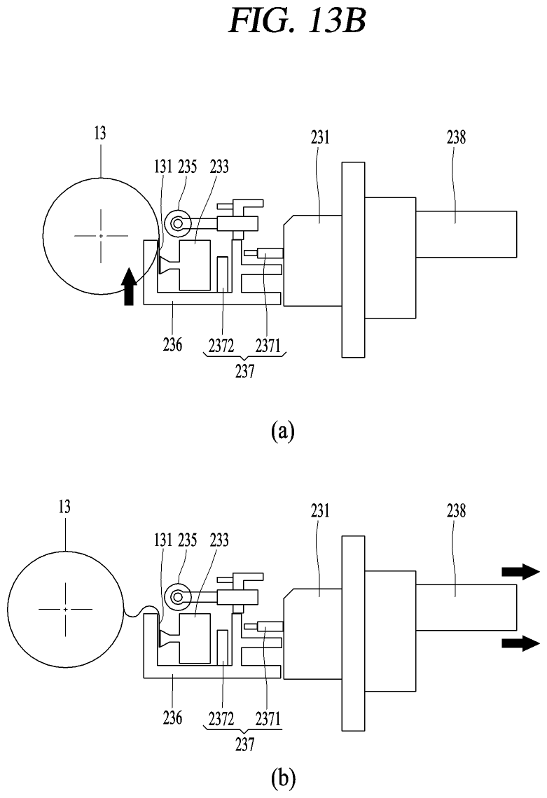

The film adsorption part 233 adsorbs and grips one surface (in detail, the adsorption region 134 of the standby film roll 13) at an end side of the thin film 131 wound on the standby film roll 13 (see FIG. 13A).

The film adsorption part 233 can be configured to have a polyhedral shape with a preset thickness and area.

A plurality of air inlet holes are disposed in a front surface of the film adsorption part 233. The front surface of the film adsorption part 233 is directed toward the adsorption region 134 of the standby film roll 13.

The film adsorption part 233 moves forward to the adsorption region 134 of the standby film roll 13 and sucks air to adsorb the adsorption region 134 of the standby film roll 13, and then, moves backward. Accordingly, the thin film 131 wound on the standby film roll 13 becomes unwound.

After the tape adsorption part 232 removes the finishing tape 17 attached to the one surface 133 of the thin film 131 neighboring an end of the thin film 131, the film adsorption part 233 moves backward.

The film adsorption part 233 is placed on the head body part 231 to be apart from the sensing unit 234 and the tape adsorption part 232, and disposed in a position in which the adsorption region 134 of the standby film roll 13 can be adsorbed.

The film adsorption part 233 can be provided in plurality. For example, as shown in FIGS. 8 to 12, two film adsorption parts 233 can be placed at both sides to have the tape adsorption part 232 in a middle in a width direction of the standby film roll 13.

The winder 1 in the present disclosure includes components that enable the film adsorption part 233 to move forward or backward, and components needed for the film adsorption part 233 to suck air.

According to an embodiment of the present disclosure, the head part 23 in the present disclosure can further include a film gripping part 236.

In other words, the winder 1 in the present disclosure can further include the film adsorption part 233 in addition to the tape adsorption part 232, and can further include the film gripping part 236 in addition to the film adsorption part 233.

### Film Gripping Part 236

The film gripping part 236 is placed on the head body part 231.

The film gripping part 236 together with the film adsorption part 233 grabs (grips) an end or an end side of the thin film 131 wound on the standby film roll 13 (see FIG. 13B).

The film gripping part 236 can be configured to have a plate shape with a preset size. The film gripping part 236 can be configured to have a polyhedral shape with a preset thickness and area.

When the film gripping part 236 is capable of gripping the end side of the thin film 131, the film gripping part 236 is not limited to a particular shape and can be configured in various shapes.

The film gripping part 236 is arranged on the head body part 231 to be spaced apart from the film adsorption part 233 by a preset distance, and placed in a position adjacent to the film adsorption part 233.

For example, the film gripping part 236 is positioned below the film adsorption part 233 in a case of the upper unwinding type, and is positioned above the film adsorption part 233 in a case of the lower unwinding type.

When a plurality of (for example, two) film adsorption parts 233 are disposed, a plurality of (for example, two) film gripping parts 236 are also disposed. For example, as illustrated in FIG. 12, the two film gripping parts 236 are positioned below the film adsorption parts 233, respectively.

When the film adsorption part 233 adsorbs one surface at the end side of the thin film 131 wound on the standby film roll 13 (in detail, the adsorption region 134 of the standby film roll 13), and then, moves backward, an end of the thin film 131 wound on the standby film roll 13 is spaced apart from the standby film roll 13 by a preset distance. At this time, the film gripping part 236 moves to come into contact with another surface at the end side of the thin film 131 wound on the standby film roll 13 (see (a) of FIG. 13B).

In detail, the end side of the thin film 131 is placed between the film adsorption part 233 and the film gripping part 236, and is grabbed (gripped) by the film adsorption part 233 and the film gripping part 236 due to a close contact between the film adsorption part 233 and the film gripping part 236. In addition, when the head part 23 moves backwards (when the head part 23 moves in a direction away from the standby film roll 13), the thin film 131 wound on the standby film roll 13 becomes unwound (see (b) of FIG. 13B).

Movement of the film gripping part 236 is performed by a gripping moving part 237.

According to an embodiment of the present disclosure, the head part 23 in the present disclosure can further include the gripping moving part 237.

### Gripping Moving Part 237

The gripping moving part 237 is placed on or connected to the head body part 231.

The gripping moving part 237 is connected to the film gripping part 236 to move the film gripping part 236.

The gripping moving part 237 includes a first cylinder part 2371 and a second cylinder part 2372 (see (a) of FIG. 13A).

The first cylinder part 2371 and the second cylinder part 2372 include a cylinder housing through which air or fluid flows in or out, a piston member movable within the cylinder housing, and a piston rod connected to the piston member and configured to be movable. The first cylinder part 2371 and the second cylinder part 2372 indicates generally used cylinder devices, and a detailed description thereof is not provided here.

The first cylinder part 2371 can be connected to the head body part 231. In addition, the first cylinder part 2371 is connected to the film gripping part 236 to move the film gripping part 236 forward or backward in a horizontal direction (see (b) of FIG. 13A).

The second cylinder part 2372 can be connected to the head body part 231. In addition, the second cylinder part 2372 is connected to the film gripping part 236 to raise or lower the film gripping part 236 in a vertical direction (see (a) of FIG. 13B).

Hereinafter, an example thereof is described (see FIGS. 13A and 13B).

When the film adsorption part 233 adsorbs one surface (in detail, the adsorption region 134 of the standby film roll 13) at an end side of the thin film 131 wound on the standby film roll 13, and then, moves backward, the film gripping part 236 is moved by the first cylinder part 2371 toward the standby film roll 13, and then, raised toward the standby film roll 13 by the second cylinder part 2372.

When the movement of the film gripping part 236 is completed by driving the first cylinder part 2371 and the second cylinder part 2372, the end side of the thin film 131 is placed between the film adsorption part 233 and the film gripping part 236, and is gripped by the film adsorption part 233 and the film gripping part 236 due to a close contact between the film adsorption part 233 and the film gripping part 236.

In addition, when the head part 23 moves backwards (when the head part 23 moves in a direction away from the standby film roll 13), the thin film 131 wound on the standby film roll 13 becomes unwound.

According to an embodiment of the present disclosure, the film gripping part 236 can include a plurality of components physically separate from each other. The plurality of components can be connected to the first cylinder part 2371 and/or the second cylinder part 2372 to be capable of moving in an upward, downward, left, or right direction when connected to the head body part 231.

The winder 1 in the present disclosure further includes components needed for the gripping moving part 237 to move the film gripping part 236.

In addition, according to an embodiment of the present disclosure, the gripping moving part 237 can include a driving motor and components connected thereto, instead of the first cylinder part 2371 and the second cylinder part 2372, to move the film gripping part 236.

According to another embodiment of the present disclosure, the winder 1 in the present disclosure can further include a film adsorption moving part (not shown).

The film adsorption moving part is placed on or connected to the head body part 231.

The film adsorption moving part is connected to the film adsorption part 233 to move the film adsorption part 233.

When the film adsorption part 233 adsorbs one surface (in detail, the adsorption region 134 of the standby film roll 13) at an end side of the thin film 131 wound on the standby film roll 13, and then, moves backward and descends, the end side of the thin film 131 wound on the standby film roll 13 is spaced apart from the standby film roll 13 by a preset distance, and the film gripping part 236 comes into contact with another surface at the end side of the thin film 131 wound on the standby film roll 13.

In detail, the end side of the thin film 131 is placed between the film adsorption part 233 and the film gripping part 236, and is grabbed (gripped) by the film adsorption part 233 and the film gripping part 236 due to a close contact between the film adsorption part 233 and the film gripping part 236. In addition, when the head part 23 moves backwards (when the head part 23 moves in a direction away from the standby film roll 13), the thin film 131 wound on the standby film roll 13 becomes unwound.

The film adsorption moving part includes a third cylinder part and a fourth cylinder part.

Like the first cylinder part 2371 and the second cylinder part 2372, the third cylinder part and the fourth cylinder part indicate cylinder devices that are generally used, and thus, a detailed description thereof is not provided here.

The third cylinder part can be connected to the head body part 231. In addition, the third cylinder part is connected to the film adsorption part 233 to move the film adsorption part 233 forward or backward in a horizontal direction.

A fourth cylinder part can be connected to the head body part 231. In addition, the fourth cylinder part is connected to the film adsorption part 233 to raise or lower the film adsorption part 233 in a vertical direction.

Hereinafter, an example thereof is described.

The film adsorption part 233 is moved forward by the third cylinder part toward the standby film roll 13, adsorbs the adsorption region 134 of the standby film roll 13, and then, is moved backward, and is raised or lowered toward the film gripping part 236 by the fourth cylinder part.

When the movement of the film adsorption part 233 is completed by the driving of the third cylinder part or the fourth cylinder part, the end side of the thin film 131 is placed between the film adsorption part 233 and the film gripping part 236, and gripped by the film adsorption part 233 and the film gripping part 236 due to a close contact between the film adsorption part 233 and the film gripping part 236.

In addition, when the head part 23 moves backward, the thin film 131 wound on the standby film roll 13 becomes unwound.

According to another embodiment of the present disclosure, the film adsorption part 233 can include a plurality of components physically separate from each other. The plurality of components can be connected to the third cylinder part and/or the fourth cylinder part to move in an upward, downward, left, or right direction when connected to the head body part 231.

The winder 1 in the present disclosure can further include components needed for the gripping adsorption moving part to move the film adsorption part 233.

In addition, according to an embodiment of the present disclosure, the gripping adsorption moving part can include a driving motor and components connected thereto, instead of the third cylinder part and the fourth cylinder part, to move the film adsorption part 233.

According to another embodiment of the present disclosure, the winder 1 in the present disclosure can include both the gripping moving part 237 and the film adsorption moving part each described above, and can grip an end side of the standby film roll 13 by driving the gripping moving part 237 and/or the film adsorption moving part.

By driving the gripping moving part 237 and/or the film adsorption moving part, the film gripping part 236 and/or the film adsorption part 233 can move to grip the end side of the standby film roll 13.

When the movement of the film gripping part 236 and/or the film adsorption part 233 is completed by driving the first cylinder part 2371 to the fourth cylinder part, the end side of the thin film 131 is placed between the film gripping part 236 and the film adsorption part 233, and gripped by the film gripping part 236 and the film adsorption part 233 due to a close contact between the film gripping part 236 and the film adsorption part 233. In addition, when the head part 23 moves backward, the thin film 131 wound on the standby film roll 13 becomes unwound.

The driving of the gripping moving part 237 and/or the film adsorption moving part is controlled by the control unit. That is, the control unit controls a movement distance, a movement speed, and pressure of a piston member (or a piston rod) of a cylinder part.

### Head Rotation Part 238

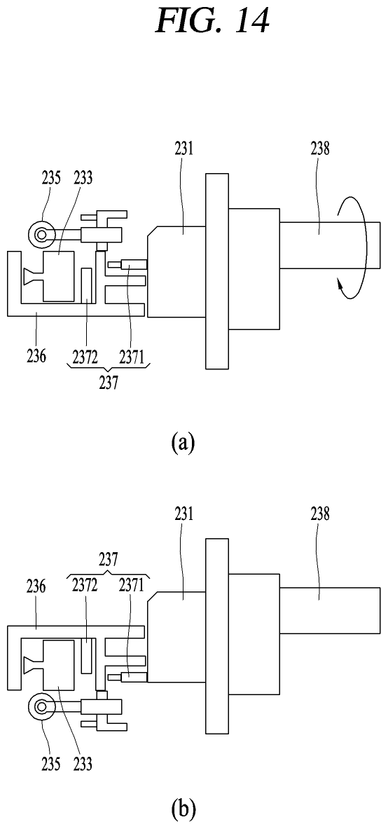

Meanwhile, the head rotation part 238 rotates the head part 23 (in detail, the head body part 231) (see FIG. 14).

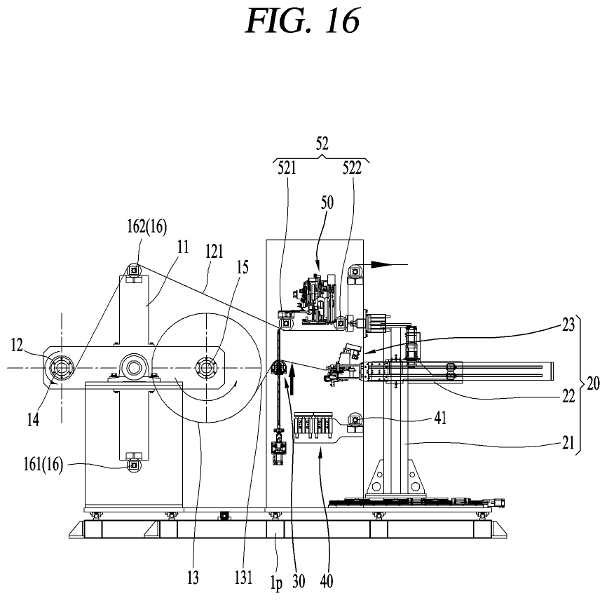

Since the head part 23 (in detail, the head body part 231) can rotate, the tape adsorption part 232, the film adsorption part 233 and the film gripping part 236 each attached to the head part 23 can grip an end side of the finishing tape 17 or the thin film 131 in both cases of the upper unwinding type and the lower unwinding type (see FIGS. 15 and 16).

Alternatively, when unwinding of the thin film 121 of the running film roll 12 or the standby film roll 13 is changed from the upper unwinding type to the lower unwinding type (or vice versa), the head rotation part 238 rotates the head part 23 (in detail, the head body part 231) to enable the film adsorption part 233 and the film gripping part 236 to grip an end side of the thin film 131.

One side of the head rotation part 238 is connected to the head body part 231, and another side of the head rotation part 238 is connected to one side of the leading part 20 (in detail, the second leading support part 22).

The head body part 231 rotates at a preset angle by the rotation of the head rotation part 238.

The head rotation part 238 includes a driving motor.

The driving motor refers to a generally used motor.

The head rotation part 238 (in detail, the driving motor) is electrically connected to the control unit and controlled by the control unit. The control unit controls a rotation angle of the head rotation part 238 (in detail, the driving motor).

When the head part 23 of the leading part 20 removes the finishing tape 17 attached to the standby film roll 13, grips the end side of the thin film 131 unwound from the standby film roll 13, and then, moves by a preset distance in a direction (a right direction in FIG. 1) away from the standby film roll 13, a process of connecting the running film roll 12 that has been running to the standby film roll 13 is performed. The process of connecting the thin films 121 and 131 unwound from two films, i.e., the running film roll 12 and the standby film roll 13, respectively, is performed approximately when the running film roll 12 is almost completely unwound.

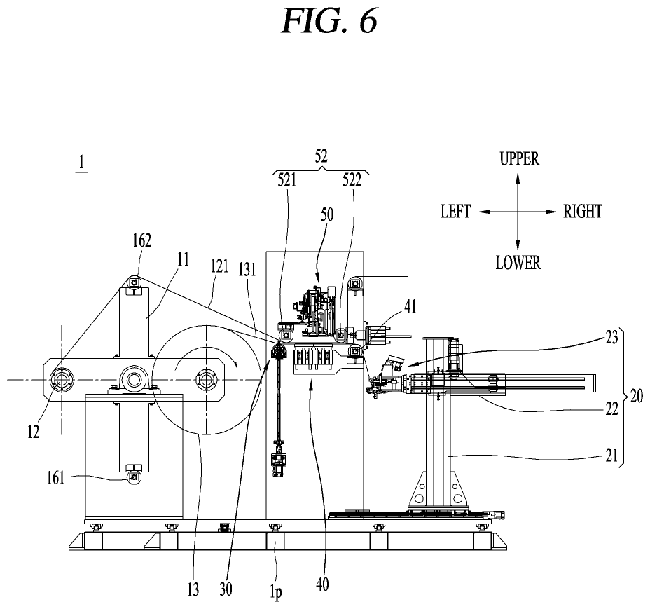

When the head part 23 moves in one direction (a right direction in FIG. 1) after gripping the end side of the thin film 131 unwound from the standby film roll 13, the guide roller 30 moves (e.g., ascends) to support one point of the thin film 131 having been unwound from the standby film roll 13 (see FIGS. 6 and 16). At this time, the guide roller 30 can be in contact with the film connecting part 50 to be described later or a roller arranged on the frame 1p. The roller can be in a state of being in contact with the thin film 121 of the running film roll 12.

### Guide Roller 30

The winder 1 in the present disclosure includes the guide roller 30.

The guide roller 30 supports the thin film 131 having been unwound from the standby film roll 13 by a certain distance (see FIGS. 6 and 16).

The guide roller 30 determines (or defines) a moving path of a thin film in both cases of the upper and lower unwinding types. In other words, the guide roller 30 enables to lead a thin film in the upper unwinding type and the lower unwinding type.

In addition, the guide roller 30 enables to lead a thin film by changing a moving path of the thin film when the upper unwinding type is changed to the lower unwinding type (or vice versa).

That is, a moving path of a thin film is determined (defined) by the guide roller 30.

The guide roller 30 is placed between the standby film roll 13 placed on the turret part 10 and the suction part 40 to be described later or the leading part 20. At this time, the leading part 20 is in a state of having moved by a preset distance in one direction (the right direction in FIG. 1) after gripping an end side of the thin film 131 unwound from the standby film roll 13.

The guide roller 30 is located below the thin film 131 unwound from the standby film roll 13.

The guide roller 30 can be raised or lowered when placed on the frame 1p.

For example, the guide roller 30 can be raised or lowered by being connected to a ball screw, a linear guide (an LM guide) and/or a driving motor each generally used.

Alternatively, according to an embodiment of the present disclosure, the guide roller 30 can be raised or lowered by a hydraulic device including a cylinder. The hydraulic device includes a pneumatic device.

The winder 1 in the present disclosure includes other components that enable the guide roller 30 to move on the frame 1p.

### Suction Part 40

The suction part 40 can be raised or lowered when placed on the frame 1p.

The suction part 40 is placed between the standby film roll 13 placed on the turret part 10, and the leading part 20. At this time, the leading part 20 is in a state of having moved by a preset distance in one direction (a right direction in FIG. 1) after gripping an end side of the thin film 131 unwound from the standby film roll 13.

The suction part 40 is located below the thin film 131 unwound from the standby film roll 13.

The suction part 40 is raised to adsorb the thin film 131 of the standby film roll 13 to fixedly support the thin film 131.

A plurality of air inlet holes are disposed in one surface (e.g., an upper surface) of the suction part 40. The suction part 40 sucks air through the air inlet hole and adsorbs the thin film 131 unwound from the standby film roll 13.

When the suction part 40 adsorbs the thin film 131, the running film roll 12 is in a stop state.

When the suction part 40 is raised to adsorb and support the thin film 131 of the standby film roll 13, the thin film 121 of the running film roll 12 and the thin film 131 of the standby film roll 13 are stacked on each other.

In other words, the thin film 121 of the running film roll 12 is placed on the thin film 131 of the standby film roll 13 adsorbed by the suction part 40. That is, the thin film 121 of the running film roll 12 is placed in an upper portion, and the thin film 131 of the standby film roll 13 is placed therebelow.

After the suction part 40 has fixed the thin film 131 by adsorbing the thin film 131 of the standby film roll 13, the leading part 20 can release the end side of the thin film 131 that has been gripped. That is, the leading part 20 can no longer grip the thin film 131.

The suction part 40 can include a roller 41 (a third roller).

The third roller 41 can be placed on one side (see FIG. 1) of an upper surface or on one side (not shown) of one side surface of the suction part 40. The one side indicates a side adjacent to the leading part 20.

The third roller 41 supports the thin film 131 adsorbed by the suction part 40.

The suction part 40 can be raised or lowered by being connected to a hydraulic device including, for example, a ball screw, a linear guide, a drive motor, or a cylinder each generally used. The hydraulic device includes a pneumatic device.

The winder 1 in the present disclosure includes other components that enable the suction part 40 to move on the frame 1p and components needed for the suction part 40 to suck air.

### Film Connecting Part 50

Referring to FIGS. 1, 17A to 17D, 18, and 19, the film connecting part 50 connects the running film roll 12 to the standby film roll 13 approximately when the running film roll 12 is almost completely unwound.

The film connecting part 50 can be raised or lowered when placed on the frame 1p.

The film connecting part 50 can be raised or lowered by being connected to, for example, a hydraulic device including a cylinder, a ball screw, a linear guide, or a drive motor. The hydraulic device includes a pneumatic device.

The film connecting part 50 is located above the thin film 121 and 131 unwound from the running film roll 12 and the standby film roll 13, respectively, on the frame 1p. At this time, the leading part 20 is in a state of having moved by a preset distance in one direction (a right direction in FIG. 1) after gripping an end side of the thin film 131 unwound from the standby film roll 13.

In detail, the film connecting part 50 is placed in an upper portion, and the suction part 40 is placed therebelow. In addition, the thin film 121 and the thin film 131 unwound from the running film roll 12 and the standby film roll 13, respectively, are placed between the film connecting part 50 and the suction part 40. At this time, the thin film 121 of the running film roll 12 is placed in an upper portion, and the thin film 131 of the standby film roll 13 is placed therebelow.

A plurality of rollers 52 are arranged in a periphery of the film connecting part 50.

The plurality of rollers 52 include a fourth roller 521 and a fifth roller 522.

The fourth roller 521 and the fifth roller 522 can be generally used rollers.

The fourth roller 521 and the fifth roller 522 are arranged to be spaced apart from each other by a preset distance.

The fourth roller 521 and the fifth roller 522 can be connected to both sides of the film connecting part 50 (in detail, a connecting part body 51). The connecting part body 51 indicates a body of the film connecting part 50.

In detail, the fourth roller 521 can be connected to one side (e.g., a left side in FIG. 1) of the connecting part body 51, and the fifth roller 522 can be connected to another side (e.g., a right side in FIG. 1) of the connecting part body 51.

In addition, according to an embodiment of the present disclosure, the fourth roller 521 and the fifth roller 522 can be connected to the frame 1p, and arranged at positions (at both sides of the connecting part body 51) adjacent to the connecting part body 51.

The fourth roller 521 and the fifth roller 522 can rotate when connected to the connecting part body 51 or the frame 1p.

The fourth roller 521 and the fifth roller 522 support the thin film 121 unwound from the running film roll 12, and when the running film roll 12 and the standby film roll 13 are connected to each other, support the thin film 121 unwound from the running film roll 12 and the thin film 131 unwound from the standby film roll 13. In addition, the fourth roller 521 and the fifth roller 522 support the thin film 131 unwound from the standby film roll 13 (i.e., the running film roll 12).

Other rollers can be further arranged on the frame 1p to support the thin film 121 unwound from the running film roll 12. The other rollers can include a tension roller, and the tension roller can control tension (or a degree of tightness) of the thin film 121 unwound from the running film roll 12.

Hereinafter, a process of, by the film connecting part 50, connecting the thin film 121 unwound from the running film roll 12 to the thin film 131 unwound from the standby film roll 13 is described in detail.

When the thin film 121 of the running film roll 12 and the thin film 131 of the standby film roll 13 are stacked on each other between the film connecting part 50 and the suction part 40, the film connecting part 50 is lowered downwardly.

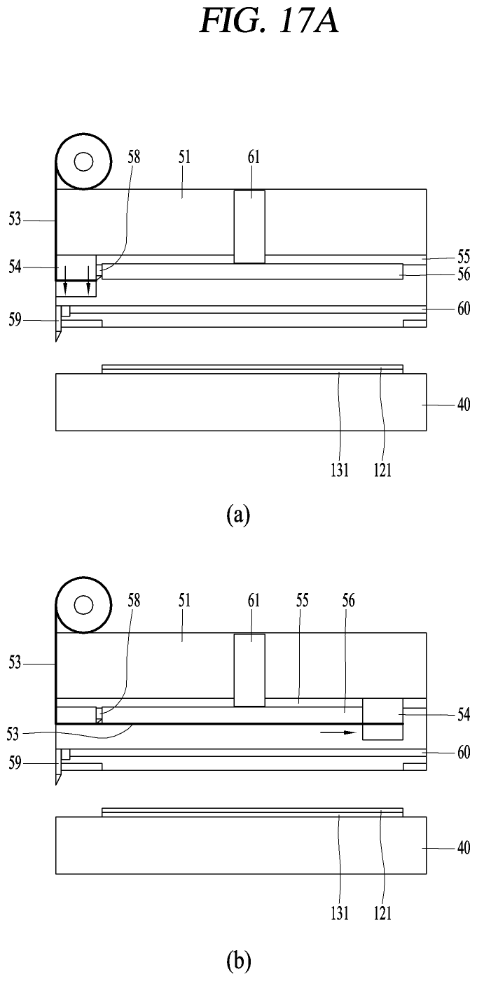

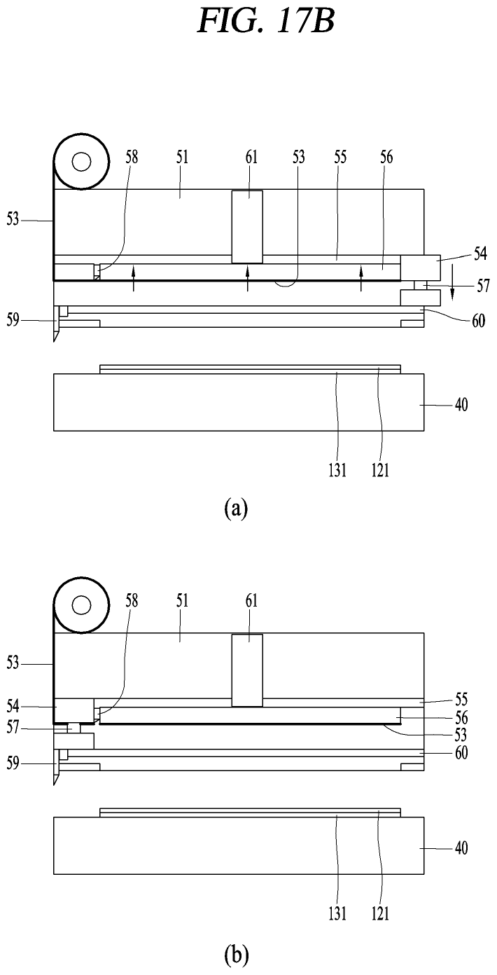

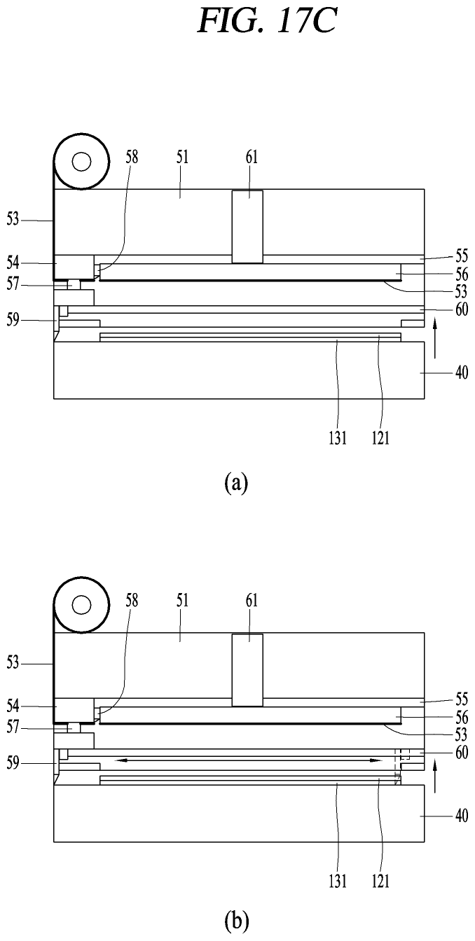

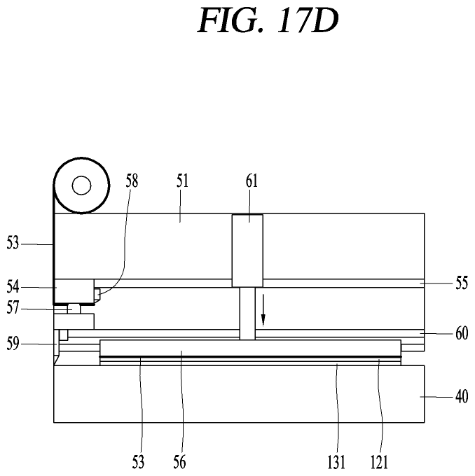

A connection tape 53 is unwound to a preset length from a roll on which the connection tape 53 is wound (see (a) of FIG. 17A).

The roll wound with the connection tape 53 can be placed on the connecting part body 51 or can be placed at a position adjacent to the connecting part body 51.

One surface of the connection tape 53 has no adhesive strength, and another surface has adhesive strength.

The connection tape 53 is an adhesive tape connecting the thin film 121 of the running film roll 12 to the thin film 131 of the standby film roll 13.

An end side of the connection tape 53 unwound from the roll is adsorbed to a connection tape adsorption part 54.

The connection tape adsorption part 54 is configured to have a plate shape with a preset size.

The connection tape adsorption part 54 is placed on the connecting part body 51.

The connection tape adsorption part 54 adsorbs and grips one surface at the end side of the connection tape 53.

A plurality of air inlet holes are disposed in one surface of the connection tape adsorption part 54. The one surface of the connection tape adsorption part 54 is directed toward the one surface at the end side of the connection tape 53.

The winder 1 in the present disclosure includes components that enable the connection tape adsorption part 54 to move and other components needed to suck air.

(2) The connection tape adsorption part 54 sucks air to adsorb the one surface at the end side of the connection tape 53, and moves in one direction along a guide member 55 (a first guide member) (see (b) of FIG. 17A).

The first guide member 55 can be a generally used linear guide (LM guide), and is arranged on (or connected to) the connecting part body 51 in one direction.

The first guide member 55 guides the connection tape adsorption part 54 to move in the one direction.

When the connection tape adsorption part 54 moves in one direction along the first guide member 55, the connection tape 53 becomes unwound from the roll on which the connection tape 53 is wound, and the end side of the connection tape 53 adsorbed by the connection tape adsorption part 54 moves together with the connection tape adsorption part 54.

A connection tape pressing part 56 is arranged at one side of (e.g., below) the first guide member 55.

The connection tape pressing part 56 is configured to have a block shape and has a preset length. The preset length is arranged in a same direction (one direction) as that of the first guide member 55.

In detail, the connection tape pressing part 56 includes one end portion and another end portion, and the one end portion and the another end portion of the connection tape pressing part 56 are arranged in one direction along the first guide member 55.

When the connection tape adsorption part 54 moves in the one direction along the first guide member 55, the connection tape adsorption part 54 moves from the one end portion to the another end portion of the connection tape pressing part 56. At this time, the connection tape 53 having been unwound from the roll on which the connection tape 53 was wound is placed below the connection tape pressing part 56. In addition, another surface (an adhesive surface) of the connection tape 53 is directed downward.

(3) The connection tape pressing part 56 adsorbs and grips the one surface of the connection tape 53 placed below (see (a) of FIG. 17B).

A plurality of air inlet holes are disposed in one surface (e.g., a lower surface) of the connection tape pressing part 56. The one surface (the lower surface) of the connection tape pressing part 56 is directed toward one surface (e.g., an upper surface) of the connection tape 53.

By adsorbing the connection tape pressing part 56, the upper surface of the connection tape 53 is adsorbed onto the lower surface of the connection tape pressing part 56. At this time, the another surface (the adhesive surface) of the connection tape 53 is directed downward.

The winder 1 in the present disclosure includes components needed for the connection tape pressing part 56 to suck air.

When the connection tape pressing part 56 grips the one surface of the connection tape 53, the connection tape adsorption part 54 does not perform the adsorption any more but releases the connection tape 53.

The connection tape adsorption part 54 is connected to a cylinder part 57 (a fifth cylinder part). The fifth cylinder part 57 indicates a generally used cylinder device, and a detailed description thereof is not provided here.

The connection tape adsorption part 54 can be raised or lowered by the fifth cylinder part 57. That is, the fifth cylinder part 57 lowers the connection tape adsorption part 54.

In addition, according to an embodiment of the present disclosure, the winder 1 in the present disclosure can include a driving motor and components connected thereto instead of the fifth cylinder part 57, and the connection tape adsorption part 54 can be raised or lowered by the driving motor and the components connected thereto.

(4) The connection tape adsorption part 54 lowered by the fifth cylinder part 57 moves in an opposite direction to the one direction along the first guide member 55 and returns to an original position (see (b) of FIG. 17B).

In addition, a connection tape cutting unit 58 placed at the one end portion of the connection tape pressing part 56 cuts the connection tape 53. At this time, the connection tape cutting unit 58 cuts the connection tape 53 in a width direction of the connection tape 53.

As the connection tape 53 is cut by the connection tape cutting unit 58 at a certain point, the connection tape 53 cut to have a preset size is adsorbed onto one surface of the connection tape pressing part 56.

(5) The suction part 40 is placed below the connection tape pressing part 56. On an upper surface of the suction part 40, the thin film 121 of the running film roll 12 and the thin film 131 of the standby film roll 13 are stacked on each other (see (a) of FIG. 17C).

When the connection tape 53 is cut, the suction part 40 is raised or the film connecting part 50 (in detail, the connecting part body 51) is lowered.

(6) The thin-film cutting unit 59 disposed in the connecting part body 51 cuts the thin film 121 of the running film roll 12 and the thin film 131 of the standby film roll 13 stacked on each other (see (b) of FIG. 17C). The thin-film cutting unit 59 can be positioned on a lower side of the connecting part body 51 to cut the thin films 121 and 131 stacked on each other.

Since the thin-film cutting unit 59 cuts the stacked thin films 121 and 131, cut surfaces of the stacked thin films 121 and 131 align with each other.

In detail, since the thin-film cutting unit 59 vertically cuts the thin film 121 of the running film roll 12 and the thin film 131 of the standby film roll 13 stacked on each other, the thin film 121 of the running film roll 12 and the thin film 131 of the standby film roll 13 have cutting surfaces aligned with each other in a vertical direction.

The thin-film cutting unit 59 moves in one direction along a guide member 60 (a second guide member) to cut the stacked thin films 121 and 131.

The second guide member 60 can be a generally used linear guide (LM guide), and is arranged on (or connected to) the connecting part body 51 in one direction.

The second guide member 60 guides the thin-film cutting unit 59 to move in one direction.

When the thin-film cutting unit 59 moves in one direction along the second guide member 60, the thin film 121 of the running film roll 12 and the thin film 131 of the standby film roll 13 stacked on each other are cut in a width direction.

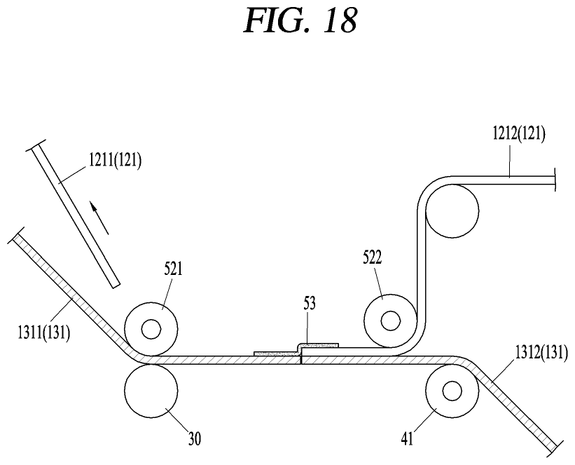

When the stacked thin films 121 and 131 are cut, the running film roll 12 placed on the turret part 10 rotates to wind a thin film 1211 (a first running thin film) connected to the running film roll 12 (see FIG. 18).

Accordingly, when an upper surface of the suction part 40 is viewed from above, a thin film 1311 (a first standby thin film) connected to the standby film roll 13 disposed on the turret part 10 and a thin film 1212 (a second running thin film) cut (separated) from the running film roll 12 are arranged on the upper surface of the suction part 40.

(7) The connection tape pressing part 56 moves (e.g., is lowered) toward the suction part 40. Accordingly, the connection tape 53 adsorbed by the connection tape pressing part 56 comes into contact with the first standby thin film 1311 and the second running thin film 1212 to connect the first standby thin film 1311 to the second running thin film 1212 (see FIG. 17D).

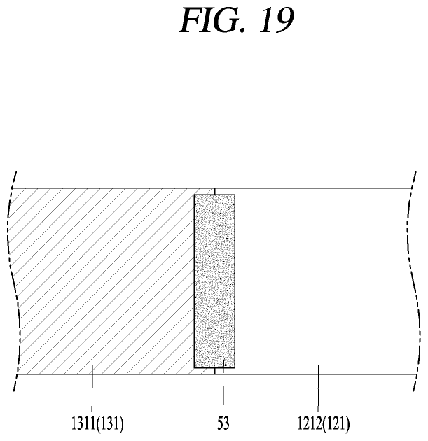

The adhesive surface of the connection tape 53 covers a cut surface of the first standby thin film 1311 and a cut surface of the second running thin film 1212 from above, thereby connecting the thin film 1311 (the first standby thin film) of the standby film roll 13 to the thin film 1212 (the second running thin film) cut (separated) from the running film roll 12 (see FIG. 19).

The connection tape pressing part 56 is connected to a cylinder part 61 (a sixth cylinder part). The sixth cylinder part 61 indicates a generally used cylinder device, and a detailed description thereof is not provided here.

The connection tape pressing part 56 can be raised or lowered by the sixth cylinder part 61. That is, the sixth cylinder part 61 lowers the connection tape pressing part 56.

In addition, according to an embodiment of the present disclosure, the winder 1 in the present disclosure can include a driving motor and components connected thereto instead of the sixth cylinder part 61, and the connection tape pressing part 56 can be raised or lowered by the driving motor and the components connected thereto.

Through the above-described process, since the thin film 131 unwound from the standby film roll 13 is connected to the thin film 121 separated from the running film roll 12, the standby film roll 13 becomes unwound consecutively after the running film roll 12 is unwound.

Meanwhile, a thin film 1312 (a second standby thin film) cut (separated) from the standby film roll 13 is gripped by the head part 23 of the leading part 20 and moves toward a bottom side of the frame 1p by movement of the leading part 20.

As such, the film connecting part 50 connects the thin film 1311 connected to the standby film roll 13 to the thin film 1212 separated from the running film roll 12 in a position in which the thin film 121 unwound from the running film roll 12 and the thin film 131 unwound from the standby film roll 13 are cut. Accordingly, effects of preventing connection portions of the thin films 1311 and 1212 from being misaligned, reducing manufacturing time for the winder 1, simplifying a manufacturing process, and reducing a manufacture cost can be obtained.

### Control Unit

The winder 1 in the present disclosure includes the control unit (not shown).

The control unit can be placed on the frame 1p and can be placed outside the frame 1p by an electrical connection.

The winder 1 in the present disclosure is operated and controlled by the control unit.

The control unit includes various electrical and electronic components and is electrically connected to the components described above in the present disclosure.

In addition to operations related to application programs, the control unit generally controls all operations of the winder 1 in the present disclosure.

The control unit can provide or process appropriate information or functions to a user by processing signals, data, information, etc. input or output through the above-described components or operating an application program stored in a memory.

Additionally, the control unit can control at least some of the above-described components to execute a command input by the user and/or an application program stored in the memory. Furthermore, the control unit can operate at least two or more of the components included in the winder 1 in the present disclosure in combination to execute a command input by a user and an application program.

What is claimed is:

1. A winder comprising:
a turret part configured to hold a standby film roll; and
a leading part comprising a head part configured to sense a finishing tape attached to an end side portion of a thin film wound on the standby film roll, grip the finishing tape, and remove the finishing tape from the standby film roll, the head part comprising:
a head body part;
a sensing unit disposed on the head body part and configured to sense the finishing tape;
a tape adsorption part disposed on the head body part and configured to move to a position of the finishing tape sensed by the sensing unit, temporarily couple to the finishing tape, and remove the finishing tape from the end side portion of the thin film wound on the standby film roll; and
a head rotation part configured to rotate the head body part when the thin film wound on the standby film roll becomes unwound.

2. The winder of claim 1, wherein the tape adsorption part moves forward to an adsorption region of the finishing tape, sucks air to temporarily couple to the adsorption region of the finishing tape, and moves backward after the tape adsorption part is temporarily coupled to the adsorption region of the finishing tape.

3. The winder of claim 1, wherein the head part further comprises a film adsorption part disposed on the head body part and configured to grip a first surface of the thin film at an end side portion of the thin film wound on the standby film roll.

4. The winder of claim 3, wherein the film adsorption part moves forward to an adsorption region of the standby film roll, and sucks air to temporarily couple to the adsorption region of the standby film roll, and wherein the film adsorption part moves backward after the tape adsorption part removes the finishing tape attached to the first surface of the thin film located at the end side portion of the thin film wound on the standby film roll.

5. The winder of claim 3, wherein the head part further comprises a film gripping part disposed on the head body part and configured to grip the end side portion of the thin film wound on the standby film roll, together with the film adsorption part.

6. The winder of claim 5, wherein, when the film adsorption part is temporarily coupled to the first surface of the thin film at the end side portion of the thin film wound on the standby film roll, and moves backward, an end portion of the thin film is spaced apart from the standby film roll by a preset distance, and the film gripping part moves to come into contact with a second surface of the thin film at the end side portion of the thin film, and
wherein the end side portion of the thin film is placed between the film adsorption part and the film gripping part, and is gripped by the film adsorption part and the film gripping part.

7. The winder of claim 5, wherein, when the film adsorption part is temporarily coupled to the first surface of the thin film at the end side portion of the thin film wound on the standby film roll, and moves backward and descends, an end portion of the thin film is spaced apart from the standby film roll by a preset distance, and the film gripping part comes into contact with a second surface of the thin film at the end side portion of the thin film, and
wherein the end side portion of the thin film is placed between the film adsorption part and the film gripping part, and is gripped by the film adsorption part and the film gripping part.

8. The winder of claim 1, further comprising a guide roller,
wherein, when the head part moves in a direction away from the standby film roll by a preset distance after gripping the end side portion of the thin film unwound from the standby film roll, the guide roller moves and supports one point of the thin film to define a moving path of the thin film.

9. The winder of claim 1, further comprising:
a running film roll located on the turret part;
a film connecting part configured to connect the running film roll and the standby film roll; and
a suction part disposed below the film connecting part and configured to temporarily couple to a thin film unwound from the standby film roll to fix the thin film to the suction part,
wherein a thin film unwound from the running film roll and the thin film unwound from the standby film roll are stacked on each other and are placed between the film connecting part and the suction part.

10. The winder of claim 9, further comprising a connection tape located on the film connection part, a portion of the connection tape becoming unwound to a preset length from a roll of the connection tape,
wherein one surface at an end side portion of the connection tape is gripped by a connection tape adsorption part.

11. The winder of claim 10, wherein the connection tape adsorption part is temporarily coupled to the one surface at the end side portion of the connection tape, and moves in one direction along a first guide member.

12. The winder of claim 11, further comprising a connection tape pressing part disposed below the first guide member,
wherein, when the connection tape adsorption part moves in the one direction along the first guide member, the connection tape adsorption part moves from a first end portion to a second end portion of the connection tape pressing part, and the connection tape unwound from the roll of the connection tape is disposed below the connection tape pressing part.

13. The winder of claim 12, wherein the connection tape pressing part is temporarily coupled to and grips the connection tape disposed below the connection tape pressing part, and
wherein the connection tape adsorption part releases the connection tape, and moves in an opposite direction to the one direction along the first guide member to return to an original position.

14. The winder of claim 13, further comprising a connection tape cutting unit disposed on the first end portion of the connection tape pressing part,
wherein the connection tape cutting unit cuts the connection tape at one point, and
wherein the connection tape is cut to have a preset size and is temporarily coupled onto one surface of the connection tape pressing part.

15. The winder of claim 14, further comprising a thin-film cutting unit, wherein, when the connection tape is cut, the suction part is raised or the film connecting part is lowered, and wherein the thin-film cutting unit disposed on the film connecting part cuts the thin film unwound from the running film roll and the thin film unwound from the standby film roll, the thin films being stacked on each other, while moving in the one direction along a second guide member.

16. The winder of claim 15, wherein the connection tape pressing part moves toward the suction part, and the connection tape temporarily coupled to the connection tape pressing part connects the thin film unwound from the standby film roll to the thin film unwound from the running film roll.

17. The winder of claim 1, wherein the tape adsorption part is located in between a pair of thin film fixing parts, the pair of thin film fixing parts being configured to temporarily couple to the end side portion of the thin film wound on the standby film roll.

18. The winder of claim 17, wherein the pair of thin film fixing parts are located between a pair of film adsorption parts, the pair of film adsorption parts being configured to temporarily couple to the end side portion of the thin film wound on the standby film roll.

19. The winder of claim 1, wherein the tape adsorption part is configured to temporarily couple to the finishing tape at an adsorption region located at an end portion of the finishing tape.

20. A winder comprising:
a turret part configured to receive a standby film roll; and
a leading part comprising a head part configured to sense a finishing tape attached to an end side portion of a thin film wound on the standby film roll, grip the finishing tape, remove the finishing tape from the standby film roll, and start unrolling the standby film roll, the head part comprising:
a head body part;
a sensing unit disposed on the head body part and configured to sense the finishing tape;
a tape adsorption part disposed on the head body part and configured to remove the finishing tape from the end side portion of the thin film wound on the standby film roll; and
a film adsorption part configured to temporarily couple to the end side portion of the thin film wound on the standby film roll,
wherein, when the leading part moves backward from the standby film roll while the film adsorption part is temporarily coupled to the end side portion of the thin film wound on the standby film roll, the standby film roll is unwound.
